(19) United States
(12) Patent Application Publication
(10) Pub. No.: US 2013/0013659 A1
(43) Pub. Date: Jan. 10, 2013

(54) METHOD FOR STREAMING SVD COMPUTATION FIELD OF INVENTION

(75) Inventors: Pankaj Kankar, Gurgaon (IN); Anukool Lakhina, Gurgaon (IN); Rajesh Singh, Gurgaon (IN)

(73) Assignee: GUAVUS NETWORK SYSTEMS PVT. LTD., Gurgaon, Haryana (IN)

(21) Appl. No.: 13/636,863

(22) PCT Filed: Mar. 24, 2011
(86) PCT No.: PCT/IN2011/000199

§ 371 Date: Sep. 24, 2012

(30) Foreign Application Priority Data
Mar. 25, 2010 (IN) 711/DEL/2010

(51) Int. Cl. G06F 17/16; G06F 17/14

(52) U.S. Cl. 708/401

(57) ABSTRACT

The present disclosure is directed to techniques for efficient streaming SVD computation. In an embodiment, streaming SVD can be applied for streamed data and/or for streamed processing of data. In another embodiment, the streamed data can include time series data, data in motion, and data at rest, wherein the data at rest can include data from a database or a file and read in an ordered manner. More particularly, the disclosure is directed to an efficient and faster method of computation of streaming SVD for data sets such that errors including reconstruction error and loss of orthogonality are error bounded. The method avoids SVD re-computation of already computed data sets and ensures updates to the SVD model by incorporating only the changes introduced by the new entrant data sets.

CROSS-REFERENCE TO RELATED PATENT APPLICATIONS

This application is a U.S. National Phase Application under 35 U.S.C. §371 of International Patent Application No. PCT/IN2011/000199, filed Mar. 24, 2011, and claims the priority of Indian Patent Application No. 711/DEL/2010, filed Mar. 25, 2010, all of which are incorporated by reference herein.

### FIELD OF INVENTION

The present invention relates to calculation of streaming singular value decomposition (SVD). In particular, the invention relates to a method of more efficient, fast, and error bounded streaming computation of SVD for streamed data and/or for streamed processing of data.

### BACKGROUND OF THE INVENTION

Singular value decomposition (SVD), apart from having applications in fields such as image processing, data mining, dynamic system control, dimensionality reduction, and feature selection, also finds application in analysis of computer network data, which include datasets of packets transferred from one location to another and values thereof.

Typically, SVD is used for low rank approximation of an m*n matrix M. SVD of an m*n matrix M transforms the matrix M into U*W*V^{T} format where U is an m×m matrix, V is an n×n matrix, and W is a m×n diagonal matrix. The number of non-zero diagonal entries in W represents the number of independent dimensions in M and is referred to as the rank of matrix M, denoted by r. The entries in the diagonal of W are in decreasing order. This order is indicative of the proportion of variance/energy captured by the projected dimensions. Many a times, it is possible to approximate the original matrix M using only the top k<<r projected dimensions. If only the top k dimensions of M are considered, then these dimensions represent the normal space having energy above a predefined threshold. The remaining r-k dimensions form part of the residual space and demonstrate very little information. Reconstructing the matrix M based on the top-k dimensions is also referred to as a low rank approximation of M (more specifically, a k-rank approximation of M). Such reduction in the dimensionality of the matrix from r to k dimensions, where k<<r, enables faster and efficient processing of the matrix at much lower computational complexity.

Typically, even though low-rank approximations transform the matrix from r dimensions to top k projected dimensions, choosing the top k dimensions produces errors such as reconstruction errors. Further, in case of streaming data or streamed processing of data, introduction of a new data set at each iteration requires SVD to be computed for the complete matrix at each such iteration, which involves costly re-computation on the previous entries of data sets, Such re-computation of already computed entries of data sets can be avoided by incorporating only the changes introduced by the new entrant data sets. One such method has been disclosed by Matthew Brand's paper titled “Fast Online SVD revisions for lightweight recommender systems”. However, the proposed incremental calculation for only the new entrant data sets may result in loss of orthogonality and reconstruction error beyond acceptable threshold.

Further, there are often instances when the matrix can be divided into blocks of data having same normalization values or values that fall in a defined range, and computing streaming SVD on the entire matrix of data rather than on such blocks requires significantly higher computational time due to normalization step that needs to be carried out for the matrix after each iteration. Furthermore, computing sliding SVD on such a matrix having different normalization values also becomes difficult and computationally expensive.

There is therefore a need for an efficient method for calculating streaming SVD for streamed data and/or for streamed processing of data with tolerable reconstruction error and loss of orthogonality.

### SUMMARY

The present disclosure is directed to techniques for efficient streaming SVD computation. In an embodiment, streaming SVD can be applied for streamed data and/or for streamed processing of data. In another embodiment, the streamed data can include time series data, data in motion, and data at rest, wherein the data at rest can include data from a database or a file and read in an ordered manner. More particularly, the disclosure is directed to an efficient and faster method of computation of streaming SVD for data sets such that errors including reconstruction error and loss of orthogonality are error bounded. The method avoids SVD re-computation of already computed data sets and ensures updates to the SVD model by incorporating only the changes introduced by the new entrant data sets.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a flowchart of an efficient streaming SVD computation method for streamed data and/or for streamed processing of data.

FIG. 2 illustrates a flowchart of an efficient Sliding Streaming SVD (SSVD) computation method for streamed data and/or for streamed processing of data.

FIG. 3 illustrates a flowchart of an efficient Split and Merge SVD (SMSVD) computation method for streamed data and/or for streamed processing of data.

### DETAILED DESCRIPTION OF PREFERRED EMBODIMENTS

This disclosure is directed to techniques for efficient streaming SVD computation. In an embodiment, streaming SVD can be applied for streamed data and/or for streamed processing of data. In another embodiment, the streamed data can include time series data, data in motion, and data at rest, wherein the data at rest can include data from a database or a file and read in an ordered manner. Streamed data can further include periodic, non-periodic, and/or random data. More particularly, the disclosure is directed to an efficient and faster method of computation of streaming SVD for data sets such that errors including reconstruction error and loss of orthogonality are error bounded. The method avoids SVD re-computation of already computed data sets and ensures updates to the SVD model by incorporating only the changes introduced by the new entrant data sets.

The details disclosed below are provided to describe the following embodiments in a manner sufficient to enable a person skilled in the relevant art to make and use the disclosed embodiments. Several of the details described below, however, may not be necessary to practice certain embodiments of the invention. Additionally, the invention can include other embodiments that are within the scope of the claims but are not described in detail with respect to the following description. In the following section, an exemplary environment that is suitable for practicing various implementations is described. After this discussion, representative implementations of systems and processes for computing streaming SVD are described.

In an embodiment, streaming singular value decomposition can be computed on an m*n matrix of data to choose k dimensions which capture an eigen energy of over a predefined threshold such as 97% forming normal subspace. The k dimensions are identified such that k<<r, wherein r represents the rank of the complete matrix. Identification of the k dimensions transforms the matrix from U_{m*m}*W_{m*n}*V^{T}_{n*n} to a U_{m*k}*W_{k*k}*V^{T}_{k*n}. Using k dimensions instead of N dimensions brings down the computational complexity of the matrix from O(mn²) to O(mnk).

In an embodiment, once an SVD is computed for the matrix, a decision as to whether the matrix needs to be divided into blocks is made. A matrix can be divided into blocks for faster SVD computation based on multiple parameters such as whether the data points in the matrix have same normalization values or have values that fall in very different ranges. The matrix can also be divided into blocks when faster and parallel processing is possible and required.

In case division of the matrix into blocks is not needed, a partial SVD (PSVD) can be computed for f (k) dimensions. The basic concept of PSVD has been explained in a paper from Rasmus Munk Larsen titled “Lancoz bidiagonalization with partial reorthogonalization”. For instance, in an embodiment if f(k)=2k, PSVD would be computed on 2*k dimensions. Based on the Dopplinger effect, the approximation error identified while doing the k rank approximation (also referred to as choosing k dimensions) is found to be acceptable till k/2 dimensions are computed and shoot up immediately thereafter. Selection of 2*k dimensions for computation of the PSVD therefore ensures that the k dimensions resulting from the PSVD computation would contain error within an acceptable bound.

In an embodiment, reconstruction error can be computed after computation of the PSVD to identify if the reconstruction error is within the predefined threshold. In another embodiment, both relative and absolute reconstruction errors can be identified, wherein relative reconstruction error can be identified through computation of ∥(X−U*W*VT)∥/∥X∥ and absolute reconstruction error can be identified using ∥X−U*W*VT∥. If the reconstruction errors are not within predefined thresholds, SVD needs to be computed again to identify new set of top k dimensions that have the reconstruction errors within the threshold levels.

Further to the computation of PSVD on the entire matrix, sliding singular value decomposition (SSVD) can be computed by calculation of streaming SVD values only for the new entering data points rather than for the complete matrix. SSVD computation includes representation of the matrix with k dimensions into X′=X+AB^{T} format, wherein X represents the matrix at a particular instant N and X′ represents the resultant matrix at another instant N′. Such transformation of the matrix into X+AB^{T} format allows the complexity of the resultant matrix to become O(mk³+n). For instance, in case a new row of data points needs to be added, complexity of the transformed resultant matrix X+AB^{T} can be reduced to O(mk³+n) by replacing and/or casting only the new data point or the entering data point at instant N′ by the leaving data point of the instant N′, and excluding the other data sets of the matrix from the current calculation. “A” represents a matrix in m*1 matrix format and “B” represents a matrix in [X_{new state}−X_{old state}] in a 1*n matrix format. Multiplication of matrix A and matrix B allows replacement of the outgoing data set by the entering data set that avoids SVD recomputation of the remaining data sets. In an embodiment, SSVD can be computed after p new data point entries, wherein p can be any value equal to or more than 1.

In yet another embodiment, for each iteration of SSVD computation, reconstruction error can be computed for the resultant matrix. For instance, after one iteration of the SSVD, the matrix after SSVD can be transformed into U′ₖ*W′ₖ*V′^{T} and its reconstruction error, both in relative and absolute forms can be calculated. In case the reconstruction error exceeds the predefined thresholds, SVD for the matrix can be computed again. In case the reconstruction error is within the predefined threshold, a check for loss of orthogonality can be done in U and V to verify that the columns of U and V are respectively orthonormal to each other. Both relative and absolute check for loss of orthogonality can be done for the vectors. For instance, relative check can include verification of ∥(V^{T}*V)∥/∥V∥ and absolute check can be include verification of ∥V^{T}*V−I∥ value. In an embodiment, in case the measure of loss of orthogonality is more than a predefined threshold, PSVD needs to be recomputed. SSVD can further be used for modifying, adding, and deleting row and column data sets of the resultant matrix. In many applications of SVD, prior to computing the SVD of a matrix M, the matrix M needs to be mean centered. In the case of SSVD, such mean centering also needs to be performed and preserved. In an embodiment, SSVD can also be used for recentering the matrix, which is lost after the introduction of new data points. Recentering can be used for bringing the column mean of the resultant matrix to the origin point by further recasting of the matrix X′ to X′+A′B′^{T}=X″, wherein B′=[μ_{old}_{_{—}}ₘₑₐₙ−μ_{new}_{_{—}}ₘₑₐₙ] and A′=[1, 1 . . . 1].

In an embodiment, in case the matrix needs to be divided into blocks based on the ranges of normalization values of the data points of the matrix or based on the requirement of parallel processing, the matrix can be split into blocks. PSVD can then be computed on each block for 2*K dimensions. Dividing the matrix into blocks having same normalization values helps in avoiding the heavy computation involved in the normalization step that needs to be executed for each data point of the entire matrix after each iteration of sliding SVD. In an embodiment, reconstruction error can be computed for each block after computation of the PSVD to identify if the reconstruction error is within a predefined threshold. If the reconstruction error for any of the blocks is not within the predefined threshold, SVD needs to be computed again to identify new set of top k dimensions that have the reconstruction errors within the threshold levels.

In case the reconstruction error for each block is within the predefined threshold, SSVD can be computed for each block iteratively for each entry of the new data point. This step is primarily done for each block to avoid normalization of the entire resultant matrix, as each block is configured to have same normalization values and therefore does not need normalization to be carried out after every step, which otherwise is to be done each time an SSVD is to be computed for each entry of new data point of the complete matrix. Computing an SSVD individually for each of the identified blocks avoids such normalization to be done as all such blocks have normalization values in a specific range and therefore do not require the normalization to be done at every iteration. Reconstruction error and measure of loss of orthogonality can be checked at each iteration of SSVD in each individual block of the matrix. In case the reconstruction error is greater than a predefined threshold, SVD can be recomputed and in case the measure of loss of orthogonality is greater than a predefined threshold, PSVD can be recomputed for the respective block.

At the time of analysis of the resultant matrix, values of each block of the resultant matrix can be normalized and merged together to form the final matrix. Exemplary working of the method for computing streaming SVD is now discussed with reference to a flowchart.

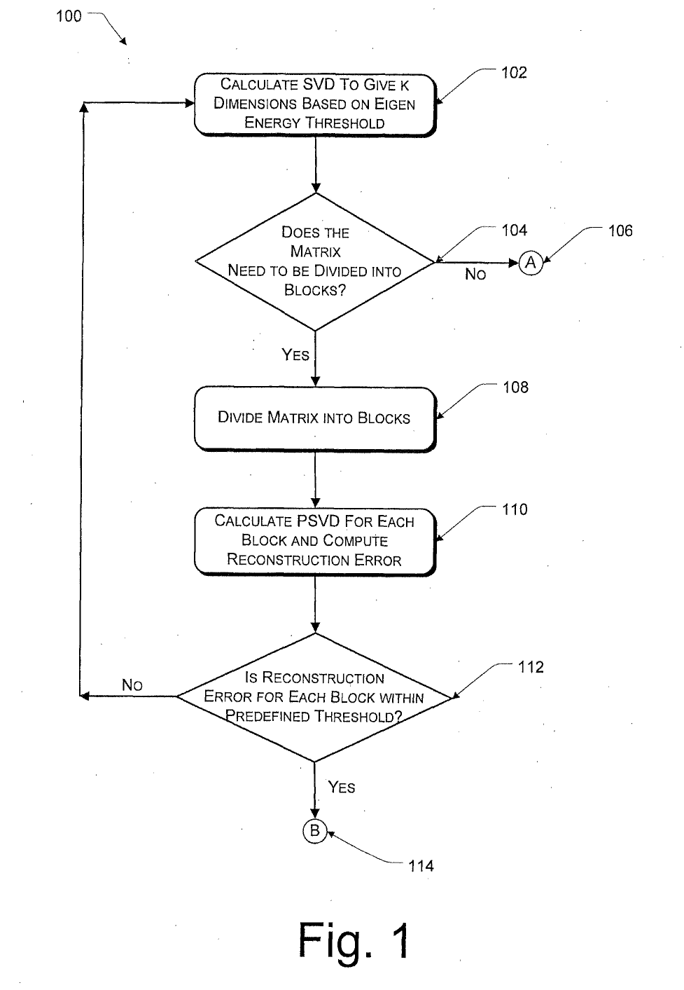

FIG. 1 illustrates a flowchart of an efficient streaming SVD computation method for streamed data and/or for streamed processing of data.

At block 102, streaming singular value decomposition (SVD) can be computed on an m*n matrix of data to identify k dimensions that represent the normal space and define eigen energy above a predefined threshold such as 95%. The SVD can therefore be computed based on a predefined eigen energy threshold. The k dimensions are identified such that k<<n, Identification of the k dimensions transforms the matrix from a U_{m*m}*W_{m*n}*V^{T}_{m*n} format to a U_{m*k}*W_{k*k}*V^{T}_{k*n} format bringing the complexity of the data set down from O(mn²) to O(mnk).

At block 104, a decision as to whether the matrix needs to be divided into blocks is made. The m*n matrix can be divided into blocks based on multiple parameters. In an embodiment, the matrix can be divided into blocks based on the normalization values of the data sets, wherein each block can includes data sets having normalization values within a specific range. For instance, one block can include data sets that represent the age of a person and therefore would typically fall in the range of 1-100 and the other block can include data sets that represent the monthly income of a person and therefore would typically fall in the range of 10000-100000. In another embodiment, the matrix can also be divided in blocks for parallel processing of the entire matrix.

At block 106, the matrix is not divided into blocks and sliding singular value decomposition (SSVD) is computed for the entire matrix. At block 108, on the other hand, a decision to divide the matrix is taken and the matrix is split into B number of blocks, wherein each block typically includes data sets having normalization values in a defined range.

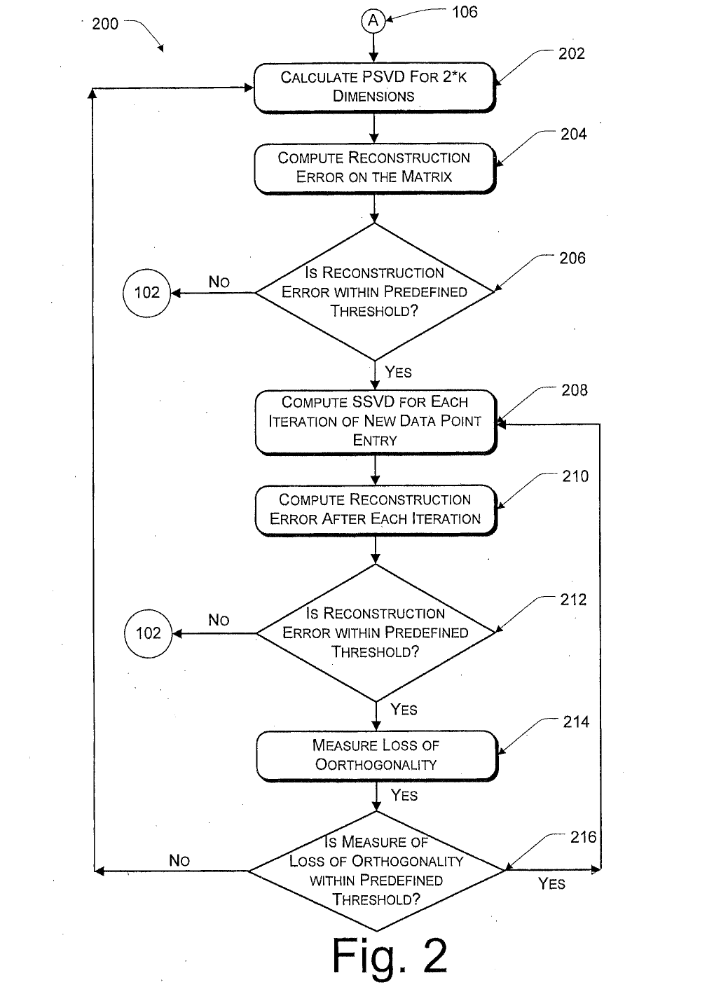

FIG. 2 illustrates a flowchart of an efficient SSVD computation method on the entire matrix for streamed data and/or for streamed processing of data.

At block 106, the matrix is not divided into blocks and SSVD is computed on the entire matrix for the new entering data points. At block 202, partial SVD (PSVD) can be computed for f(k) dimensions. In an embodiment f(k) is equal to 2*k dimensions. As discussed earlier, the error identified while doing the k rank approximation (also referred to as choosing k dimensions) is found to be acceptable till k/2 dimensions are identified and shoot up immediately thereafter. Selection of 2*k dimensions for computation of the PSVD therefore ensures that the k dimensions resulting from the PSVD computation would contain an error that is bounded within an acceptable limit.

At block 204, reconstruction error can be computed after computation of the PSVD to identify if the reconstruction error is within the predefined threshold. In another embodiment, both relative and absolute reconstruction errors can be identified, wherein relative reconstruction error can be identified through computation of ∥(X−U*W*VT)∥/∥X∥ and absolute reconstruction error can be identified using ∥X−U*W*VT∥. At block 206, if the reconstruction errors are not within predefined thresholds, SVD needs to be computed again to identify new set of top k dimensions that have the reconstruction errors within the threshold levels.

At block 208, in case the reconstruction error is within the predefined threshold, SSVD is calculated after each iteration for the new entering data point. SSVD computation includes calculation of SVD values only for the new entering data points rather than for the complete matrix. SSVD computation includes representation of the matrix with k dimensions into X′=X+AB^{T} format, wherein X represents the matrix at a particular instant N and X′ represents the resultant matrix at another instant N′. In an embodiment, instants N and N′ can be timestamps during which the new data point enters into the computational matrix. Such transformation into X+AB^{T} format allows the complexity of the resultant matrix to become O(Mk³+N) by replacing/casting only the new data point or the entering data point at instant N′ by the leaving data point of the instant N′, and excluding the other data sets of the matrix from the current calculation. “A” represents. M*1 matrix format and B represents [X new state−X old state] in a 1*N matrix format. Multiplication of matrix A and matrix B allows replacement of the outgoing data set by the entering data set that avoids SVD recomputation of the remaining data sets.

At block 210, reconstruction error is computed after each iteration for the resultant matrix. For instance, after one iteration of the SSVD, the matrix after PSVD can be transformed into U′_{m*k}*W′_{k*k}*V^{T}_{k*n}. and its reconstruction error, both in relative and absolute forms can be calculated.

At block 212, in case the reconstruction error exceeds the predefined threshold, SVD for the matrix needs to be computed again. At block 214, in case the reconstruction error is within the predefined threshold, a check for loss of orthogonality can be done in U and V to verify that the columns of U and V are respectively orthonormal to each other. Both relative and absolute check for the loss of orthogonality can be done for the vectors.

At block 216, the measure of loss of orthogonality is compared with a predefined threshold. In case the measure of loss of orthogonality is more than the predefined threshold, PSVD needs to be recomputed. On the other hand, in case the measure of loss of orthogonality is within the predefined threshold, SSVD for the next iteration or the new entry data point can be computed. In another embodiment, in case the measure of loss of orthogonality is more than a predefined threshold, SVD can again be computed.

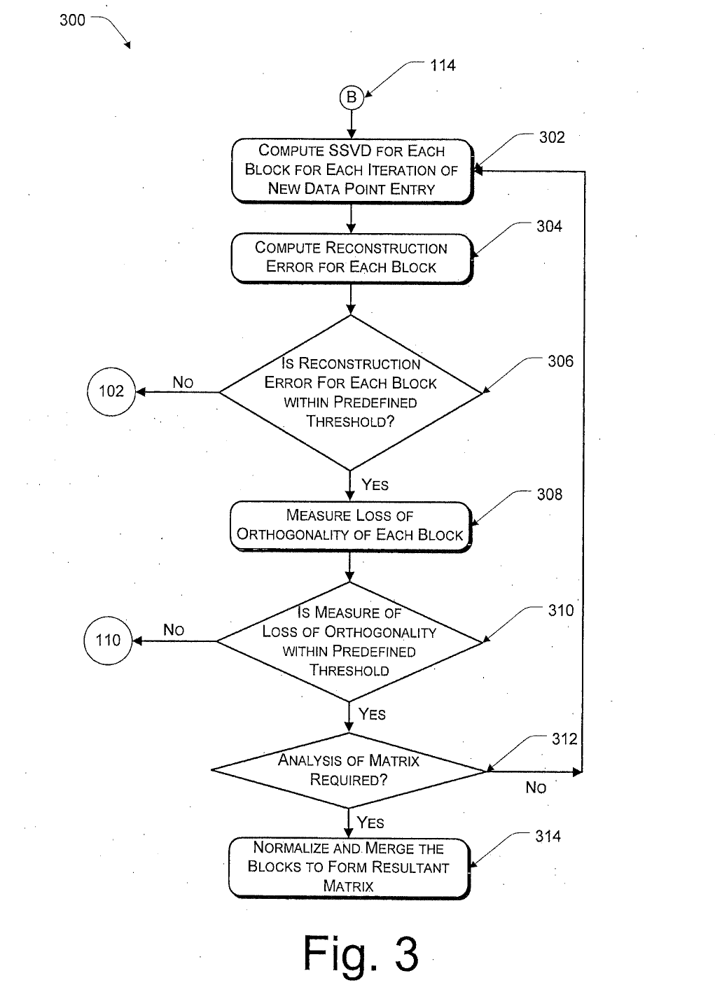

FIG. 3 illustrates a flowchart of an efficient SMSVD computation method for streamed data and/or for streamed processing of data.

At block 108, the matrix is split into B number of blocks, wherein each block typically includes data sets having normalization values in a defined range. At block 110, PSVD can be computed for each block on 2*k/B dimensions and reconstruction error can be computed for each block after computation of the PSVD to identify if the reconstruction error is within a predefined threshold.

At block 112, if the computed reconstruction error for any of the blocks is not within the predefined threshold, SVD needs to be computed again to identify new set of top k dimensions that have the reconstruction errors within the threshold levels.

At block 302, in case the reconstruction error for each block is within the predefined threshold, SSVD can be computed for each block iteratively for each entry of the new data point. Computing an SSVD for each identified block avoids normalization to be done for all such blocks, which otherwise needs to be done after each iteration in case the SSVD is computed on the complete matrix as, for SSVD to be computed on a matrix, all blocks should be equally normalized with the norm of the respective block.

At block 304, reconstruction error is computed for each block. At block 306, in case the computed reconstruction error is not within the predefined threshold, SVD needs to be computed again to identify new set of top k dimensions that have the reconstruction errors within the threshold levels.

At block 308, in case the computed reconstruction error for each block is within the predefined threshold, measure of loss of orthogonality is done for each block. At block 310, in case the measure of loss of orthogonality is not within the predefined threshold for one or more blocks, PSVD can be recomputed for the respective block(s).

At block 312, in case the measure of loss of orthogonality is within the predefined threshold for each block, a decision as to whether an analysis for the matrix is required is done. In case the analysis for the matrix is not required, SSVD for the next entry data point is computed for one or more blocks.

At block 314, in case the analysis for the resultant matrix is required, values of each block of the resultant matrix can be normalized with their respective norms and merged together to form the final matrix.

It would be appreciated by a person skilled in the art that the proposed method for computing SVD is not only limited to one or more of image processing, data mining, dynamic system control, compression, noise suppression, dimensionality reduction, separation into normal and residual subspaces and feature selection, analysis of computer network data, but all other applications in which SVD computation is desired.

We claim:

1. A method for computing Singular Value Decomposition for streamed data and/or for streamed processing of data, comprising:
calculating singular value decomposition for matrix of said data to identify k significant dimensions;
computing partial singular value decomposition for f(k) dimensions; and
calculating sliding singular value decomposition on p new data point entries;
computing reconstruction error after computing said sliding singular value decomposition;
re-calculating said singular value decomposition for said matrix to identify new k significant dimensions if said reconstruction error is not within a defined threshold;
measuring loss of orthogonality if said reconstruction error is within said defined threshold; and
re-computing said partial singular value decomposition if said measure of loss of orthogonality is not within a second defined threshold.

2. The method as claimed in claim 1, further comprising the step of dividing said matrix into a plurality of blocks, wherein decision of dividing said matrix into said plurality of blocks is taken based on normalization values of said data of said matrix.

3. The method as claimed in claim 2, wherein said partial singular value decomposition for f(k) dimensions is conducted for each said plurality of blocks.

4. The method as claimed in claim 3, further comprising the steps of
computing reconstruction error after computing said partial singular value decomposition for said f(k) dimensions; and
re-calculating said singular value decomposition for said matrix to identify new k significant dimensions if said reconstruction error is not within a defined threshold.

5. The method as claimed in claim 2, wherein said sliding singular value decomposition is computed for each of said plurality of blocks.

6. The method as claimed in claim 2, wherein said reconstruction error is computed for each of said plurality of blocks.

7. The method as claimed in claim 2, wherein said loss of orthogonality is measured for each of said plurality of blocks.

8. The method as claimed in claim 1, wherein f(k)=2*k.

9. The method as claimed in claim 1, wherein value of said p is ‘1’, further wherein after calculating said sliding singular value decomposition for each iteration, said new matrix X′ is equal to X+AB^{T}, wherein X is matrix after previous iteration, A is of [1.1.1 . . . ] in m*1 matrix format and B is of [X_{new state}−X_{old state}] in 1*n matrix format.

10. The method as claimed in claim 9, further comprising the step of mean centering said matrix by recasting said matrix X′ to X′+A′B′^{T}=X″, wherein B′=[μ_{old}_{_{—}}ₘₑₐₙ−μ_{new}_{_{—}}ₘₑₐₙ] and A′=[1, 1 . . . 1].

11. The method as claimed in claim 1, wherein said sliding singular value decomposition is used for modifying, adding, and deleting row and column data of said matrix.

12. The method as claimed in claim 1, wherein said streaming Singular Value Decomposition is used in one or more of image processing, data mining, dynamic system control, compression, noise suppression, dimensionality reduction, separation into normal and residual subspaces and feature selection, and analysis of computer network data.

13. A method for computing Singular Value Decomposition for streamed data and/or for streamed processing of data, comprising:
calculating singular value decomposition for matrix of said data to identify k significant dimensions; and
calculating sliding singular value decomposition on p new data point entries
computing reconstruction error after computing said sliding singular value decomposition; and
re-calculating said singular value decomposition if said reconstruction error is not within a defined threshold
measuring loss of orthogonality if said reconstruction error is within said defined threshold; and
re-calculating said singular value decomposition if said measure of loss of orthogonality is not within a second defined threshold.

14. The method as claimed in claim 13, further comprising the step of dividing said matrix into a plurality of blocks, wherein decision of dividing said matrix into said plurality of blocks is taken based on normalization values of said data of said matrix.

15. The method as claimed, in claim 13, wherein said streaming data is data in motion, wherein said data in motion continuously arrives at collection point.

16. The method as claimed in claim 13, wherein said streaming data is data at rest, wherein said data at rest is read in an ordered manner.
